(19) United States
(12) Patent Application Publication
(10) Pub. No.: US 2026/0195774 A1
(43) Pub. Date: Jul. 9, 2026

(54) DETERMINISTIC COMPLIANCE GATE FOR CLINICAL ARTIFICIAL INTELLIGENCE

(71) Applicant: George William Bickerstaff, III, Greenwich, CT (US)

(72) Inventor: George William Bickerstaff, III, Greenwich, CT (US)

(21) Appl. No.: 19/454,445

(22) Filed: Jan. 21, 2026

(51) Int. Cl. G06Q 30/018

(52) U.S. Cl. CPC G06Q 30/018

(57) ABSTRACT

A deterministic compliance gate for clinical artificial intelligence enforces hardware-assisted, pre-computational regulatory constraints on artificial intelligence inference outputs. Inference outputs are intercepted at execution boundaries and evaluated against validation baseline profiles associated with specific model versions. Cryptographically verifiable clearance tokens authorize execution only when compliance conditions are satisfied, preventing non-compliant artificial intelligence outputs from influencing clinical workflows or treatment decisions.

### TECHNICAL FIELD

The present invention relates to computer-implemented systems for governance, safety, and regulatory enforcement of artificial intelligence deployed in clinical environments.

More particularly, the invention relates to deterministic, hardware-assisted compliance gates that intercept artificial intelligence-assisted clinical inference outputs at defined execution boundaries and prevent non-compliant outputs from influencing clinical workflows, medical records, or treatment decisions.

### BACKGROUND

Artificial intelligence systems are increasingly deployed to assist clinicians with diagnostics, prognostics, triage, and treatment planning in regulated healthcare environments.

Such systems may influence high-impact or irreversible clinical actions, including diagnostic classification, treatment escalation, clinical reporting, or care pathway selection, where erroneous or non-compliant outputs may result in patient harm, regulatory exposure, or legal liability.

Regulatory frameworks governing clinical decision-support systems require that deployed artificial intelligence models operate within validated configurations, approved performance envelopes, and defined post-market conditions over time.

Existing governance approaches primarily rely on pre-deployment validation, retrospective audit, or application-layer monitoring, none of which deterministically prevent a non-compliant inference from entering a live clinical workflow.

Model drift, unauthorized retraining, configuration changes, or data distribution shifts may cause deployed models to operate outside validated conditions without immediate detection.

Software-only controls may be bypassed through misconfiguration, defects, or malicious interference, allowing non-compliant inferences to propagate into downstream clinical systems.

Accordingly, there exists a need for a deterministic, execution-level enforcement mechanism that prevents artificial intelligence outputs from being executed within clinical workflows unless compliance conditions are verified prior to execution.

### SUMMARY OF THE INVENTION

The disclosed invention provides a deterministic compliance gate for clinical artificial intelligence.

A hardware-assisted execution boundary interceptor captures artificial intelligence inference outputs prior to execution within a clinical workflow.

A hardware-isolated regulatory governance engine evaluates the captured inference outputs against a validation baseline profile associated with a specific model version identifier.

Upon successful verification, a cryptographically verifiable clearance token is generated and bound to the inference output.

Execution of the inference output is authorized only when the clearance token is present and verified; otherwise, execution is deterministically blocked, frozen, or escalated for review prior to influencing clinical systems.

### DEFINITIONS (ALPHABETICAL ORDER)

Clearance Token: A cryptographically verifiable artifact authorizing downstream execution of an artificial intelligence inference output after deterministic compliance verification.
Drift Metric: A quantitative measurement of deviation between deployed model behavior and a validation baseline profile.
Execution Boundary: A point within a clinical workflow at which an artificial intelligence inference output would influence or determine a high-impact or irreversible action.
Hardware-Locked Pre-Computational Gate: A cooperative hardware-software enforcement mechanism operating at an execution boundary that prevents downstream execution of artificial intelligence outputs unless predetermined compliance conditions are satisfied.
Model Version Identifier: An immutable identifier representing a specific trained instance of an artificial intelligence model, including architecture, parameters, and training lineage.
Regulatory Governance Engine: A system component configured to evaluate artificial intelligence inference outputs against machine-readable compliance and validation criteria.
Trusted Execution Environment (TEE): A hardware-isolated execution environment that protects code and data from unauthorized modification or inspection.
Validation Baseline Profile: A reference profile defining approved performance characteristics, configuration parameters, and operating boundaries for a specific model version.
Violation Signal: A deterministic signal generated upon failure to satisfy one or more compliance conditions.
Zero-Trust Execution Posture: An enforcement model in which downstream execution is denied by default unless explicitly authorized.

### BRIEF DESCRIPTION OF THE DRAWINGS

FIG. 1 illustrates deterministic compliance gate placement at a clinical execution boundary.

FIG. 2 illustrates hardware-locked governance isolation within a trusted execution environment.

FIG. 3 illustrates inference-to-baseline comparison and drift detection.

FIG. 4 illustrates cryptographic clearance token generation and binding.

FIG. 5 illustrates autonomous escalation and human-in-the-loop workflows.

### DETAILED DESCRIPTION OF THE DRAWINGS

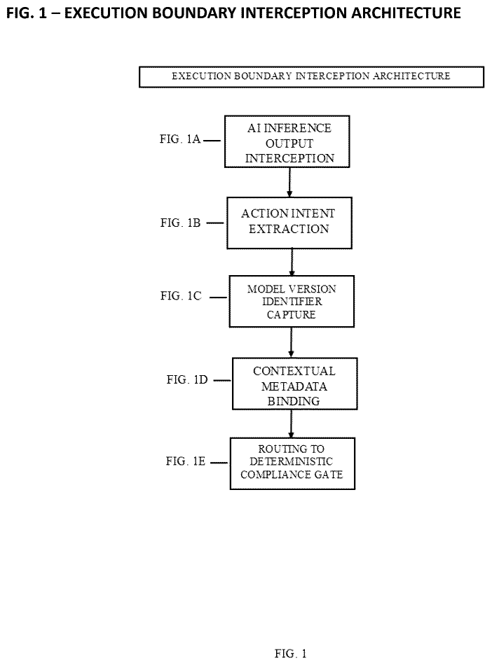

### FIG. 1—Execution Boundary Interception Architecture

FIG. 1A illustrates interception of an artificial intelligence inference output prior to entry into an electronic health record or clinical reporting system. The interceptor captures the inference output at the moment of intended clinical influence.

FIG. 1B illustrates extraction of action intent from the intercepted inference output. The system identifies the asserted clinical classification, recommendation, or risk assessment and binds the intent to the execution context.

FIG. 1C illustrates capture of a model version identifier associated with the inference output. The identifier uniquely corresponds to the deployed model instance and enables version-specific compliance enforcement.

FIG. 1D illustrates contextual metadata binding, including facility, jurisdiction, workflow stage, and patient context. The contextual metadata informs selection of applicable validation and compliance criteria.

FIG. 1E illustrates routing of the intercepted inference output to a deterministic compliance gate prior to downstream execution. All execution paths are routed through the gate, and bypass is not permitted.

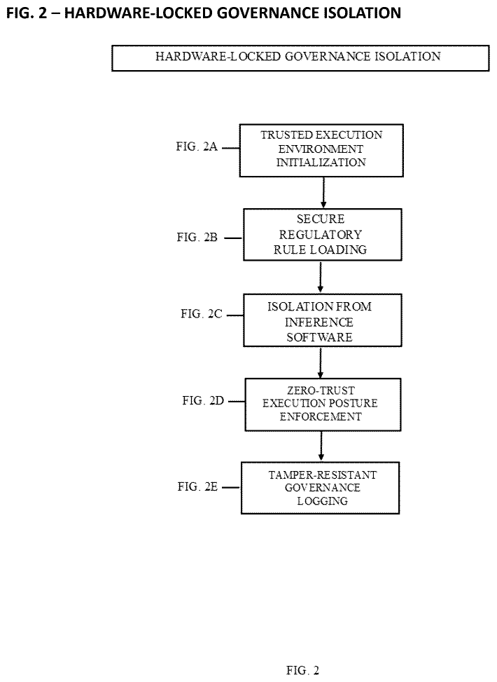

### FIG. 2—Hardware-Locked Governance Isolation

FIG. 2A illustrates execution of governance logic within a trusted execution environment. The environment is isolated from the host operating system, and code integrity is hardware enforced.

FIG. 2B illustrates secure loading of validation and compliance rules into the trusted execution environment. Rules are cryptographically verified prior to activation.

FIG. 2C illustrates isolation of governance logic from inference software. Even compromised inference software cannot bypass the compliance gate.

FIG. 2D illustrates enforcement of a zero-trust execution posture in which downstream execution is denied by default.

FIG. 2E illustrates tamper-resistant logging of compliance decisions. Governance logs are immutable and verifiable.

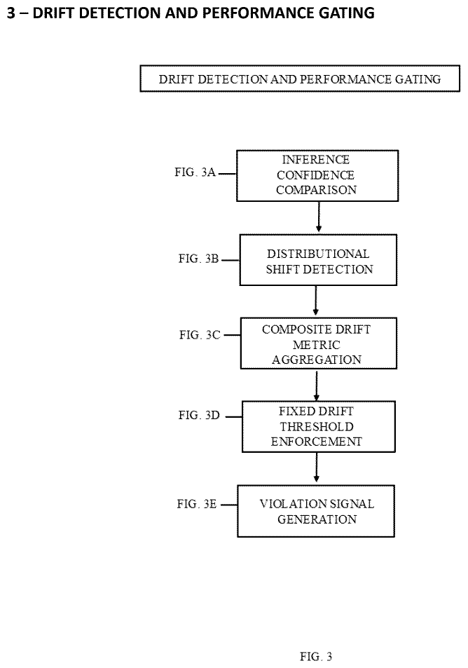

### FIG. 3—Drift Detection and Performance Gating

FIG. 3A illustrates comparison of inference confidence values to ranges defined by the validation baseline profile.

FIG. 3B illustrates detection of distributional shift relative to validated training data using statistical divergence metrics.

FIG. 3C illustrates aggregation of multiple drift metrics into a composite compliance score associated with the model version identifier.

FIG. 3D illustrates enforcement of a predetermined drift threshold associated with the validation baseline profile. Exceeding the threshold results in deterministic blocking of execution.

FIG. 3E illustrates generation of a violation signal upon failure to satisfy drift or performance criteria.

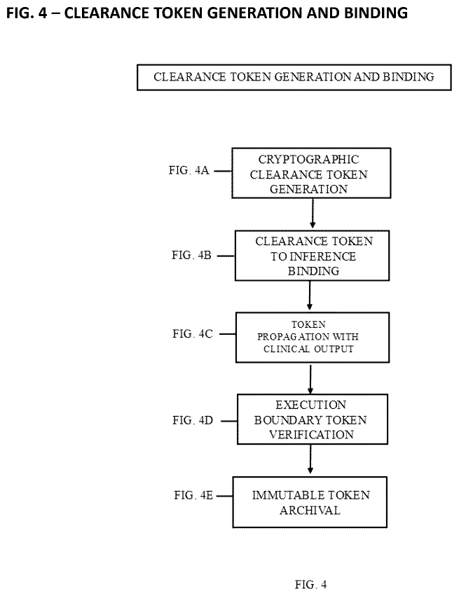

### FIG. 4—Clearance Token Generation and Binding

FIG. 4A illustrates cryptographic generation of a clearance token upon successful compliance verification within the trusted execution environment.

FIG. 4B illustrates binding of the clearance token to the inference output, including association with the model version identifier and timestamp.

FIG. 4C illustrates propagation of the clearance token with the inference output to downstream systems.

FIG. 4D illustrates verification of the clearance token at the execution boundary prior to execution.

FIG. 4E illustrates archival of the clearance token in an immutable audit log.

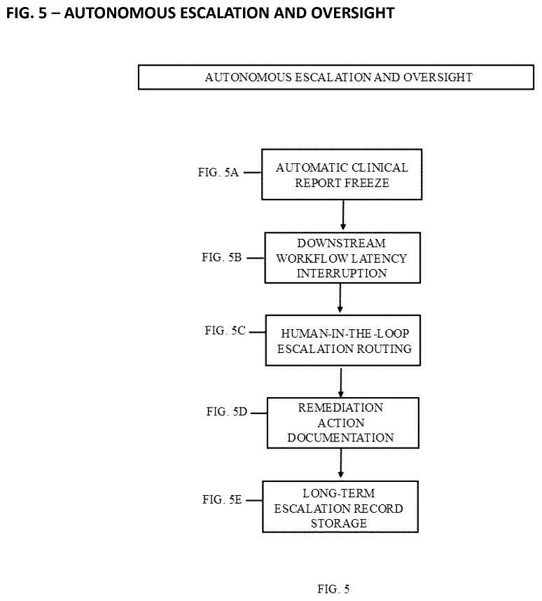

### FIG. 5—Autonomous Escalation and Oversight

FIG. 5A illustrates automatic freezing of a clinical report upon compliance failure.

FIG. 5B illustrates interruption of downstream workflows to prevent execution of a non-compliant inference output.

FIG. 5C illustrates routing of the inference output to human oversight for review.

FIG. 5D illustrates documentation of remediation actions taken in response to compliance failures.

FIG. 5E illustrates long-term storage of escalation records to support post-market surveillance and regulatory review.

### EXAMPLES

### Example 1—Prenatal Preeclampsia Risk Prediction

A prenatal artificial intelligence model generates a high-risk preeclampsia prediction during routine screening. The inference output is intercepted at an execution boundary prior to report generation. Compliance verification confirms model version validity and acceptable drift, resulting in issuance of a clearance token and authorized clinical reporting.

### Example 2—Oncology Residual Disease Detection

An oncology artificial intelligence system analyzes circulating tumor DNA to detect minimal residual disease. Drift detection identifies deviation exceeding the predetermined threshold. The system freezes the report and escalates the inference output for human review prior to any clinical action.

1. A computer-implemented system for deterministic compliance enforcement of clinical artificial intelligence, comprising:
a hardware-assisted execution boundary interceptor configured to capture artificial intelligence inference outputs prior to execution within a clinical workflow;
a hardware-isolated regulatory governance engine configured to evaluate the captured inference outputs against a validation baseline profile associated with a model version identifier; and
a pre-computational execution control gate configured to authorize downstream execution only upon verification of a cryptographically verifiable clearance token generated by the regulatory governance engine.

2. A computer-implemented method comprising:
intercepting an artificial intelligence inference output at an execution boundary;
verifying compliance of the inference output with a validation baseline profile corresponding to a model version identifier;
generating a cryptographically verifiable clearance token upon successful verification; and
deterministically authorizing or preventing downstream execution of the inference output based on verification of the clearance token.

3. A non-transitory computer-readable medium storing instructions that, when executed by one or more processors, cause performance of the method of claim 2.

4. The system of claim 1, wherein the validation baseline profile includes at least one predetermined drift threshold value.

5. The system of claim 1, wherein the regulatory governance engine executes within a trusted execution environment.

6. The method of claim 2, wherein preventing downstream execution includes freezing a clinical report pending human oversight.

7. The system of claim 1, wherein the clearance token is cryptographically bound to the model version identifier.

8. The system of claim 1, wherein compliance enforcement aligns with clinical artificial intelligence regulatory requirements.

9. The system of claim 1, wherein compliance enforcement supports post-market surveillance obligations.

10. The system of claim 1, wherein compliance decisions are recorded in an immutable audit log.
